(19) United States
(12) Patent Application Publication
(10) Pub. No.: US 2026/0299517 A1
(43) Pub. Date: Oct. 1, 2026

(54) POWER RESERVE INDICATOR

(71) Applicant: NIVAROX-FAR S.A., Le Locle (CH)

(72) Inventors: Ivan VILLAR, Brügg (CH); Gregory KISSLING, La Neuveville (CH); Roger JUILLET, Fontainemelon (CH)

(73) Assignee: NIVAROX-FAR S.A., Le Locle (CH)

(21) Appl. No.: 19/548,453

(22) Filed: Feb. 24, 2026

(30) Foreign Application Priority Data
Mar. 28, 2025 (EP) 25167179.8

(51) Int. Cl. G04B 9/00; G04B 1/14; G04B 45/02

(52) U.S. Cl. CPC G04B 9/005; G04B 1/145; G04B 45/02

(57) ABSTRACT

A timepiece with a power reserve indicator, comprising: a watchcase (1) with a transparent back (2); a barrel (6) fitted inside the watchcase (1), with the barrel (6) formed of a drum (7) closed by a cover (5) and/or a ratchet (4) ; and a barrel spring (3) fitted on a barrel axis (8) inside the barrel (6). The ratchet (4) and/or the cover (5) is pierced with at least one cutaway (10) to allow part of the barrel spring (3) to be visible through the transparent back (2), the view of the detent and tensioned states of the barrel spring (3) around the barrel axis (8) forming the power reserve indicator. The part of the barrel spring (3) have contrasting colours relative to the outer surface (4a) of the ratchet (4) and/or to the outer surface (5a) of the cover (5) to increase the visibility of the power reserve indicator.

### CROSS-REFERENCE TO RELATED APPLICATIONS

This application claims priority to European Patent Application No. 25167179.8, filed on Mar. 28, 2025, the entire contents of which are incorporated herein by reference.

### TECHNICAL FIELD OF THE INVENTION

The present invention relates to a timepiece equipped with a simplified power reserve indicator.

### TECHNOLOGICAL BACKGROUND

Power reserve indication is a well-known horology complication that generally requires dedicated components to display the available power reserve via a hand on the dial.

In the prior art, power reserve indicators with simplified designs and pierced barrels are common, making it possible to view the detent and tension states of the barrel spring through a transparent back of the watchcase.

However, these devices lack visibility and guide marks, with the user ultimately just having a view of the barrel spring with no further considerations.

### SUMMARY OF THE INVENTION

The present invention aims to provide a timepiece with a power reserve indicator with increased visibility and, optionally, means of evaluating the power reserve, with no supplementary parts.

To do so, a timepiece is proposed with a pierced barrel enabling the barrel spring to be viewed through the transparent back of the watchcase, with contrasting colours between the barrel spring and all or part of the barrel. Preferably, the back of the watchcase and/or a constituent element of the barrel is also provided with a graduation enabling the power reserve to be qualitatively or quantitatively determined.

More specifically, the invention relates to a timepiece with a power reserve indicator, said timepiece comprising:
a watchcase with a transparent back,
a barrel fitted inside the watchcase, with said barrel formed of a drum closed by a cover and/or a ratchet, with said cover and/or said ratchet comprising an outer surface arranged facing the transparent back,
a barrel spring fitted on a barrel axis inside the barrel,
said ratchet and/or said cover being pierced with at least one cutaway to allow part of the barrel spring to be visible through the transparent back, the view of the detent and tensioned states of the barrel spring around the barrel axis forming said power reserve indicator, said part of the barrel spring having contrasting colours relative to the outer surface of the ratchet and/or to the outer surface of the cover to increase the visibility of the power reserve indicator.

Preferably, the transparent back of the watchcase, the outer surface of the ratchet and/or the outer surface of the cover have one or more graduations for qualitatively or quantitatively evaluating the power reserve.

Preferably, the graduation or graduations include indications for quantitatively evaluating the power reserve.

Preferably, the graduation or graduations include a symbol or an emoji to qualitatively evaluate the power reserve.

The power reserve indicator has thus been simplified, resulting in reduced costs and increased visibility. Another advantage is that it has an amusing appearance.

### BRIEF DESCRIPTION OF THE FIGURES

FIGS. 1 and 2 show two alternative embodiments of a pierced barrel according to the invention.

FIGS. 3A and 3B show a top view of the pierced barrel with the barrel spring in the wound position and in the let-down position, respectively.

FIGS. 4A and 4B show the watchcase with its transparent back, allowing part of the pierced barrel to be viewed, with the barrel spring in the wound position and in the let-down position, respectively.

FIGS. 5-7 show various alternative colourations of the barrel spring, ratchet and barrel drum.

FIGS. 8A-8C respectively show three types of graduations on the back of the watchcase for qualitatively or quantitatively determining the power reserve.

FIG. 9 schematically shows a cross-sectional view of an interference layer on the barrel spring according to an alternative embodiment of the invention.

FIG. 10 schematically shows a cross-sectional view of the two interference layers on the barrel spring according to an alternative embodiment of the invention.

### DETAILED DESCRIPTION OF THE INVENTION

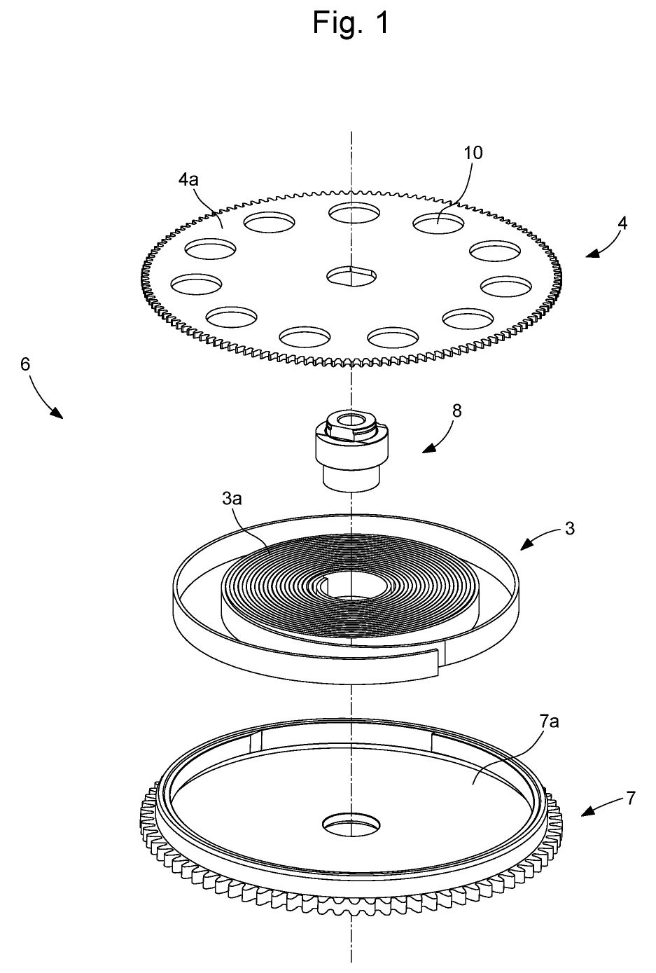

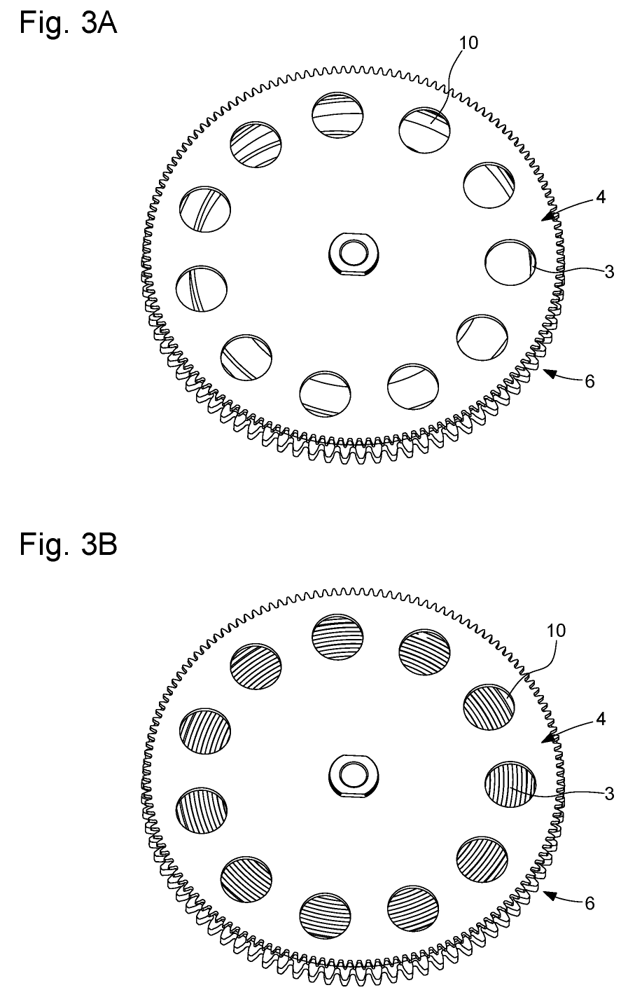

The present invention relates to a timepiece, in particular a watchcase 1, shown schematically in FIG. 4A, fitted with a transparent back 2 giving a partial view of the barrel spring 3 visible through the ratchet 4 and/or the cover 5 of the pierced barrel. In FIG. 1, the entire barrel 6 can be seen, comprising the drum 7 with its back 7a, the barrel spring 3 turned in the drum 7, the drive arbor 8 to which one end of the spring is fastened and the ratchet 4 which acts as the drum 7 cover. In an alternative embodiment in FIG. 2, the ratchet 4 is fitted in the axis of the drive arbor 8 on the cover 5 that closes the drum 7. According to the invention, the ratchet 4 and/or the cover 5 are pierced with at least one cutaway 10 to view the barrel spring 3 through the ratchet 4 and/or the cover 5. According to the invention, the alternative embodiment shown in FIG. 1 with the pierced ratchet 4 acting as a cover is preferentially chosen over the alternative embodiment shown in FIG. 2. According to the latter, the cutaways 10 are provided in the cover 5 and in the ratchet 4 with the respective cutaways at least partially aligned in order to view the barrel spring. It should be noted that the cutaways in the cover may not be the same size as the ones in the ratchet. This means that part of the cover may be visible through the cutaways in the ratchet if the cutaways in the cover are smaller than the cutaways in the ratchet. According to an alternative embodiment not shown, the cutaways are only made in the barrel cover in the space delimited by the outer diameter of the ratchet and the inner diameter of the barrel drum, the view of the barrel spring being from the outside of the ratchet.

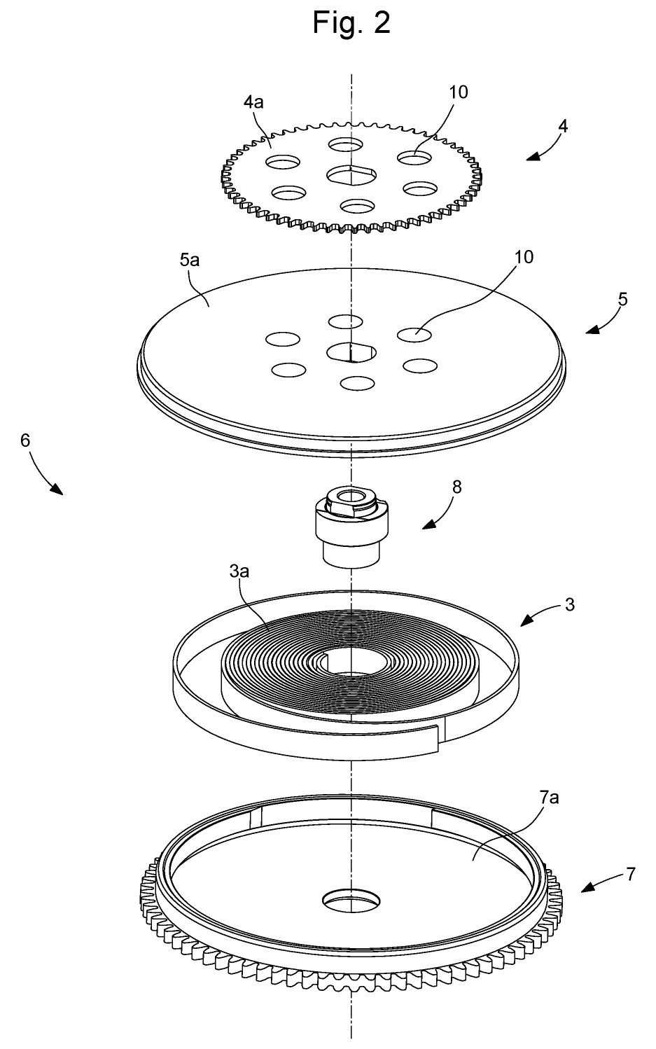

The cutaways in the ratchet and/or in the cover allow the spring's detent and tension states to be viewed. In FIGS. 3A and 4A, the barrel spring 3 can be seen in the wound state, that is, under tension, while in FIGS. 3B and 4B it is in the let-down state, that is, slack.

Various cutaway geometries are possible. For example, these can be circular holes, as shown in FIGS. 3A and 3B, or even sectors of a circle, as shown in FIGS. 4A and 4B.

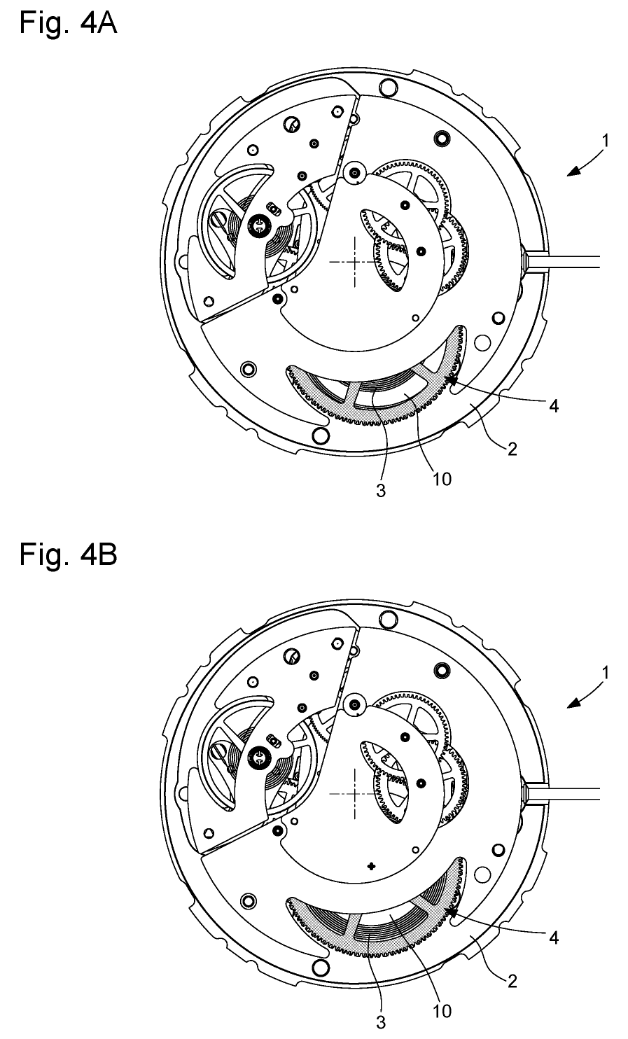

According to the invention, there is a colour contrast between at least the outer flank, referred to as 3a in FIGS. 1 and 2, of the barrel spring 3 and at least one of the following surfaces: the outer surface 4a of the ratchet 4, the outer surface 5a of the cover 5, the "outer" surface of the ratchet and of the cover corresponding to the surfaces turned toward the transparent back of the watchcase. There can also be a colour contrast between at least the outer flank 3a of the barrel spring and the inner face 7a of the back of the drum, the “inner” face of the back of the drum corresponding to the surface turned toward the transparent back of the watchcase. In the example shown in FIG. 5, the ratchet 4 and the barrel spring 3 are coloured in different colours, while the back 7a of the drum is not specifically coloured, its colour being the natural colour of the material of which it is made or of its usual plating, such as electroless Ni, DLC (Diamond Like Carbon) or even rhodium. In the example shown in FIG. 6, the ratchet 4, the barrel spring 3 and the back 7a of the drum are coloured, the ratchet 4 and the back 7a of the drum being the same colour and the barrel spring 3 being a different colour. In the example shown in FIG. 7, the ratchet 4, the barrel spring 3 and the back 7a of the drum are each coloured with different colours.

“Colours” is taken to mean colouration by interference effect following the deposition of a thin layer by ALD (Atomic Layer Deposition), colouration by galvanic or chemical deposition, colouration by inkjet printing, colouration by pad printing with lacquer or ink, or even colouration by laser texturing of the surface. Typically, for an interference effect, one or more layers are deposited with a total thickness for all the layers of less than or equal to 300 nm, the thickness being chosen according to the desired colour. For galvanic deposition or for inkjet or pad printing, the thickness of the layer is comprised between 0.1 and 2 µm.This can involve the galvanic deposition of any metal or metallic alloy of gold, nickel, rhodium or copper. Preferably, this can involve the deposition of a layer of gold or of a gold alloy.

As a preferential example, all or part of the barrel spring is treated by ALD to obtain colouration by the interference effect. In addition to colouration, this deposition of a thin layer has the advantage of improving wear resistance between the coils of the spring by reducing friction between the coils. The ALD treatment is also ideally suited to the complex form of the barrel spring.

In combination with the ALD-treated barrel spring, all or part of the ratchet, of the drum and/or of the barrel cover is coloured by galvanic or chemical deposition. For example, all or part of the ratchet 4 including at least its outer surface 4a can be gilt by galvanic deposition, while all or part of the spring 3 including at least its flank 3a has a blue colour by ALD deposition as described hereinafter. As an alternative embodiment, all or part of the spring has a purple or green colour by ALD deposit. According to another example, all or part of the ratchet including at least its outer surface and all or part of the drum including at least the back of the drum are gilt by galvanic deposition while all or part of the barrel spring including at least its flank has a blue colour by ALD deposition. According to yet another example, all or part of the ratchet including at least its outer surface is gilt by galvanic deposition, all or part of the drum is coloured in another colour, for example green, by ALD deposition, while all or part of the barrel spring including at least its flank has a blue colour by ALD deposition.

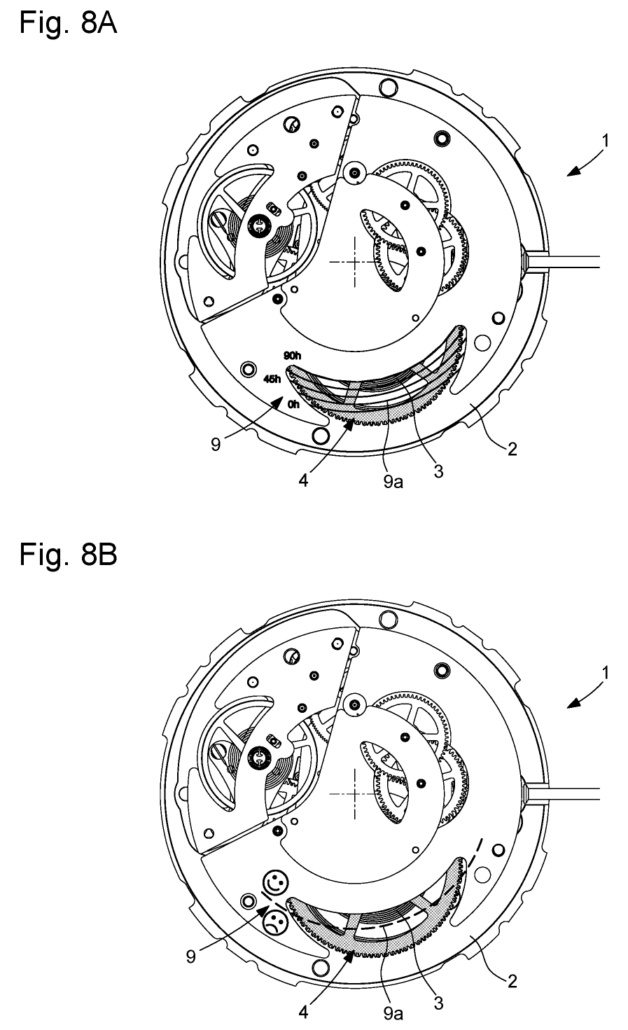

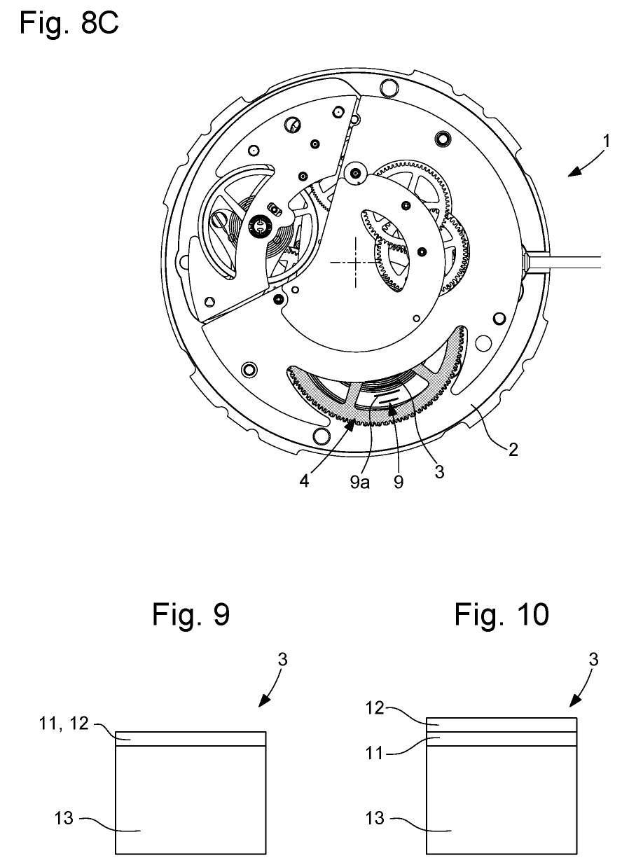

Preferably, the barrel spring is coloured by interference effect with a colour that is dependent on the thickness of the layer or layers deposited on the surface of the barrel spring. Any colour can be considered, with, however, a preference for blue. To this end, the barrel spring 3 can advantageously be plated with a layer 11 of Al₂O₃ and/or with a layer 12 of TiO₂ with, for all of the layers, a thickness of less than or equal to 125 nm to obtain a blue colour by interference effect. This resulting blue colour is intense and uniform with no need to deposit an undercoat on the base material of the substrate forming the barrel spring. As shown in FIGS. 9 and 10, the barrel spring 3 comprises a substrate 13 plated with a layer 11 of Al₂O₃ and/or a layer 12 of TiO₂. In the presence of an Al₂O₃ layer and a TiO₂ layer, the substrate is preferably plated successively with a first layer 11 of Al₂O₃ and a second layer 12 of TiO₂. According to the invention, each of the layers is advantageously deposited by ALD. Preferably, the TiO₂ or Al₂O₃ layer is in direct contact with the surface of the substrate. Although not limiting, the substrate material is more specifically a carbon steel, a maraging type steel, an austenitic stainless steel, for example 1.4310, or an austenitic cobalt-based alloy, for example Nivaflex®.

In the presence of a single layer on the substrate 13 according to the alternative embodiment in FIG. 9, the TiO₂ layer 12 has a thickness comprised between 30 and 70 nm, preferably between 35 and 55 nm, more preferentially between 40 and 52 nm, even more preferentially between 48 and 52 nm to obtain an intense blue colour. Particularly preferably, the TiO₂ layer has a thickness of 50 nm.

In the presence of a single layer on the substrate 13 according to the alternative embodiment in FIG. 9, the Al₂O₃ layer 11 has a thickness comprised between 75 and 125 nm, preferably between 90 and 110 nm, more preferentially between 95 and 105 nm, even more preferentially between 98 and 102 nm to obtain an intense blue colour. Particularly preferably, the Al₂O₃ layer has a thickness of 100 nm.

In the presence of a first layer 11 of Al₂O₃ and a second layer 12 of TiO₂ according to the alternative embodiment in FIG. 10, the first Al₂O₃ layer has a thickness comprised between 10 and 50 nm and the second TiO₂ layer has a thickness comprised between 10 and 45 nm. Preferably, the first Al₂O₃ layer has a thickness comprised between 30 and 40 nm and the second TiO₂ layer has a thickness comprised between 20 and 40 nm. More preferentially, the first Al₂O₃ layer has a thickness comprised between 32 and 38 nm and the second TiO₂ layer has a thickness comprised between 25 and 35 nm. Particularly preferably, the Al₂O₃ layer has a thickness of 35 nm and the TiO₂ layer has a thickness of 28 nm.

It should be noted that the chemical composition of the layer or layers can be analysed by EDX (Energy Dispersive X-ray Spectrometer), while the thickness of the layer or layers can be measured using ellipsometry.

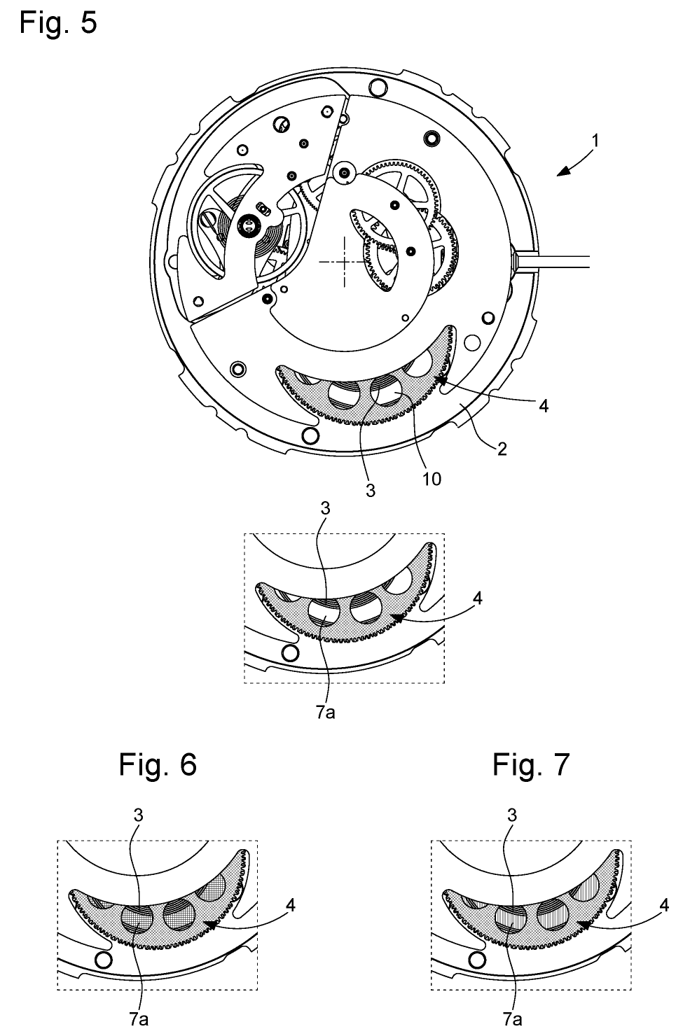

Preferably, to qualitatively or quantitatively evaluate the available power reserve, the timepiece is fitted with indicators 9 in the form of one or more graduations 9a with the positioning of the spring facing the graduations enabling the time before the spring is let down to be qualitatively or quantitatively evaluated. These power reserve indicators are preferentially engraved, for example by laser, on the transparent back of the watchcase. Alternatively or additionally, the indicators can be located on the outer surface of the ratchet or of the cover on the portions framing the cutaways. In FIG. 8A, quantitative indicators of the power reserve are shown facing each graduation, as the time remaining before let-down, for example. FIG. 8C only shows graduations 9a. In FIG. 8B, the indicator is qualitative, with a symbol or emoji positioned next to the graduation or graduations 9a. In the example shown, there is a graduation with a smiling or frowning emoji depending on whether the spring is positioned above or below the graduation 9a.

1. A timepiece with a power reserve indicator, said timepiece comprising:
a watchcase with a transparent back;
a barrel fitted inside the watchcase, with said barrel formed of a drum closed by a cover and/or a ratchet, with said cover and/or said ratchet comprising an outer surface arranged facing the transparent back; and
a barrel spring fitted on a barrel axis inside the barrel,
said ratchet and/or said cover being pierced with at least one cutaway to allow part of the barrel spring to be visible through the transparent back, the view of the detent and tensioned states of the barrel spring around the barrel axis forming said power reserve indicator, said part of the barrel spring having contrasting colours relative to the outer surface of the ratchet and/or to the outer surface of the cover to increase the visibility of the power reserve indicator.

2. The timepiece according to claim 1, wherein the transparent back of the watchcase, the outer surface of the ratchet and/or the outer surface of the cover have one or more graduations for qualitatively or quantitatively evaluating the power reserve.

3. The timepiece according to claim 1, wherein the graduation or graduations include indications for quantitatively evaluating the power reserve.

4. The timepiece according to claim 2, wherein the graduation or graduations include a symbol or emoji for qualitatively evaluating the power reserve.

5. The timepiece according to claim 1, wherein at least said part of the barrel spring is coloured.

6. The timepiece according to claim 5, wherein at least the outer surface of the ratchet and/or at least the outer surface of the cover are also coloured to increase the colour contrast relative to said part of the barrel spring.

7. The timepiece according to claim 6, wherein the drum comprises a back with an inner face turned toward the transparent back of the watchcase, said inner face also being coloured.

8. The timepiece according to claim 1, wherein said part of the barrel spring, the outer surface of the ratchet, the outer surface of the cover and/or said inner face of the back of the drum are respectively plated or textured as follows to achieve the colour contrast:
they are plated with one or more interference layers with a total thickness of 300 nm or less,
or are plated with a galvanic layer with a thickness comprised between 0.2 and 2 µm,
or are plated with an ink or lacquer layer with a thickness comprised between 0.2 and 2 µm,
or are laser textured.

9. The timepiece according to claim 8, wherein said part of the barrel spring is plated with the interference layer or layers and wherein the outer face of the ratchet and/or the outer face of the cover and/or said inner face of the back of the drum are plated with the galvanic layer.

10. The timepiece according to claim 8, wherein the galvanic layer is a layer of gold or of a gold alloy.

11. The timepiece according to claim 8, wherein said part of the barrel spring is plated with an interference layer or layers with a layer of Al₂O₃ and/or with a layer of TiO₂ having a total thickness for all of the interference layers that is less than or equal to 125 nm to obtain a blue interference colour.

12. The timepiece according to claim 11, wherein the barrel spring is plated with a layer of Al₂O₃ having a thickness comprised between 75 and 125 nm.

13. The timepiece according to claim 12, wherein the Al₂O₃ layer has a thickness comprised between 90 and 110 nm.

14. The timepiece according to claim 11, wherein said part of the barrel spring is plated with a layer of TiO₂ having a thickness comprised between 30 and 70 nm.

15. The timepiece according to claim 14, wherein the TiO₂ layer has a thickness comprised between 35 and 55 nm.

16. The timepiece according to claim 15, wherein said part of the barrel spring is successively plated with a layer of Al₂O₃ and with a layer of TiO₂ said Al₂O₃ layer having a thickness comprised between 10 and 50 nm and said TiO₂ layer having a thickness comprised between 10 and 45 nm.

17. The timepiece according to claim 16, wherein said Al₂O₃ layer has a thickness comprised between 30 and 40 nm.
